(19) United States
(12) Patent Application Publication
(10) Pub. No.: US 2017/0111372 A1
(43) Pub. Date: Apr. 20, 2017

(54) SYSTEM AND METHOD FOR SHARING OF DATA

(71) Applicant: Muzeit Limited, Tortola (VG)

(72) Inventor: Ayman Zakaria Jamaa, Knightsbridge (GB)

(21) Appl. No.: 14/940,919

(22) Filed: Nov. 13, 2015

(30) Foreign Application Priority Data
Oct. 16, 2015 (GB) 1518383.3

(51) Int. Cl. H04L 29/06; G06F 21/62

(52) U.S. Cl. CPC H04L 63/123; G06F 21/6218

(57) ABSTRACT

A server system for sharing data from a first device using a first MSISDN with a second device using a second MSISDN. The system is arranged to: receive a first media identifier from the first device, wherein the first media identifier identifies a media item; receive a first contact identifier from the first device, wherein the first contact identifier comprises the second MSISDN; identify that the media item identified by the first media identifier corresponds to a media item identified by second media identifier, wherein the second media identifier is stored by the system; and send sharing data to the second device, wherein the sharing data identifies the media item.

### RELATED APPLICATION

The present application claims priority to GB Application No. 1518383.3 filed Oct. 16, 2015, which is hereby incorporated herein in its entirety by reference.

### TECHNICAL FIELD

The present disclosure relates to a system and method for sharing data relating to media items between user devices, in particular to a system and method for sharing data relating to electronic music items or files.

### BACKGROUND ART

User devices such as mobile phones, tablets, laptops, and other portable electronic devices typically come with the capability to store or access different music libraries or libraries of other media. These libraries of media can be directly linked to the operating system running on the user device or instead can be provided by a third party and available as a software application.

Users of such devices may generate a library of music or other media which may be stored remotely at the provider of the media service or may be downloaded and stored locally on the user device, or indeed a mixture of remotely and locally stored media files. Different media providers may provide different formats for the storage or identification of media in media libraries and thus there can be incompatibilities between the various libraries which can hamper the capability of users to readily share information concerning the media libraries with one another.

Moreover, it is typical for the providers of media services for user devices, such as music services, to require users to create an account by creating a username and registering that username. However, these services do not provide the capability of verifying a particular user against a username which causes uncertainty as to whether a particular contact is genuine or not.

### SUMMARY OF THE INVENTION

According to a first aspect, there is provided a server system for sharing data from a first device using a first MSISDN with a second device using a second MSISDN, wherein the server system is arranged to: receive a first media identifier from the first device, wherein the first media identifier identifies a media item; receive a first contact identifier from the first device, wherein the first contact identifier comprises the second MSISDN; identify that the media item identified by the first media identifier corresponds to a media item identified by a second media identifier, wherein the second media identifier is stored by the server system; and send sharing data to the second device, wherein the sharing data identifies the media item.

It may alternatively be said that the server system is arranged to identify that the first media identifier corresponds to the second media identifier. The identifiers may be said to correspond because they identify the same media item. In embodiments, the first media identifier and the second media identifier are different even though they identify—for example, uniquely identify—the same media item or file—e.g. song.

Advantageously, by providing these features it is possible to enable users to browse media in a simplified manner and to enable users to easily determine and find their media. The present disclosure also resolves issues with time spent searching for media and time spent communicating with contacts about recommended media.

Advantageously, by adding and sharing media content with users based upon the MSISDN of the contacts, communication between contacts is more secure when compared with sharing contacts via a username, email, or social networking credentials since the verification occurs using a unique code which is generated for each MSISDN upon registration, and has to be verified by the software application and servers, for example via SMS. This is particularly advantageous for media sharing, such as music sharing.

The use of MSISDN provides the user with an advantage when compared with other credentials since it is easier to identify contacts and make sure that the user is the same user stored in the phonebook of the user. The approach set out above therefore provides user A with information relating to the content of the media library of user B by reference to the MSISDN (not by reference of username or social networking credentials). The server system therefore acts as a linking intermediary.

The server system may be further arranged to verify the first device, wherein the verification of the first device comprises: receiving the first MSISDN; sending an SMS to the first device, wherein the SMS comprises a verification code; and receiving data comprising the verification code.

The server system may be further arranged to verify a second device, wherein the verification of the second device comprises: receiving the second MSISDN; sending an SMS to the second device, wherein the SMS comprises a verification code; and receiving data comprising the verification code.

The server system may be further arranged to add the second media identifier to a list of second media identifiers associated with the first MSISDN.

The server system may be further configured to recommend a new media item to the first device based on at least one of: the media item identified by the first media identifier; a media item identified by a third media identifier received from the second device; and the location of the first device.

The media item may be an electronic music item. The first media identifier and/or third media identifier may be at least one of an artist name, a song name, and an album name.

According to a second aspect of the disclosure, there is provided a system comprising a first device using a first MSISDN, a second device using a second MSISDN, and the server system according to the first aspect of the disclosure.

The first device may be arranged to: extract the first media identifier from a first media library; and extract the first contact identifier from a first contact list.

The first media library may be stored on the first device. The first contact list may be stored on the first device.

The first device may be arranged to extract a fourth media identifier from a third media library, and optionally wherein the third media library is stored on the first device.

The second device may be arranged to identify that the media item corresponding to a second media identifier is in a media library stored in a server remote from the second device. The second device may be arranged to obtain the media item from the media library stored in a server remote from the second device.

It may be understood that, in embodiments, the first device may have obtained the media item from a first source—e.g. iTunes—but the second device may obtain the media item from a second source—e.g. Google Play. Accordingly, cross-format problems are solved when sharing media.

According to a third aspect of the disclosure, there is provided a method in a server system for sharing data from a first device using a first MSISDN with a second device using a second MSISDN, the method comprising: receiving a first media identifier from the first device, wherein the first media identifier identifies a media item; receiving a first contact identifier from the first device, wherein the first contact identifier comprises the second MSISDN; identifying that the media item identified by the first media identifier corresponds to a media item identified by second media identifier, wherein the second media identifier is stored by the system; and sending sharing data to the second device, wherein the sharing data identifies the media item.

The method may be further arranged to verify the first device, wherein the verification of the first device comprises: receiving the first MSISDN; sending an SMS to the first device, wherein the SMS comprises a verification code; and receiving data comprising the verification code.

The method may be further arranged to verify the second device, wherein the verification of the second device comprises: receiving the second MSISDN; sending an SMS to the second device, wherein the SMS comprises a verification code; and receiving data comprising the verification code.

The method may be further arranged to add the second media identifier to a list of second media identifiers associated with the first MSISDN.

The method may further comprise recommending a new media item to the first device based on at least one of: the media item identified by the first media identifier; a media item identified by a third media identifier received from the second device; and the location of the first device.

The media item may be an electronic music file. The first media identifier may be at least one of an artist name, a song name, and an album name.

According to a fourth aspect of the disclosure, there is provided a computer-readable medium comprising instructions which, when executed by a processor, cause the processor to implement the method of the third aspect of the disclosure.

There is also provided a method substantially as hereinbefore described with reference to the accompanying drawings and a server system substantially as hereinbefore described with reference to the accompanying drawings.

### BRIEF DESCRIPTION OF THE DRAWINGS

Embodiments will be described below, by way of example only, with reference to the accompanying drawings, in which:

FIG. 1 is an overview of a system for sharing data relating to media items according to an example of the disclosure;

FIG. 2 is an overview of the interaction of elements in the system when a new contact is added according to the system of FIG. 1;

FIG. 3 is a flowchart illustrating an example method of adding a contact to a user of the system of FIG. 1;

FIG. 4 is an overview of the interaction of elements in the system when a new user verified to the system of FIG. 1;

FIG. 5 is a flowchart illustrating an example method of verifying a user of the system of FIG. 1;

FIG. 6 is an overview of the interaction of elements in the system when a media item is shared with another device;

FIG. 7 is a flowchart illustrating an example method of sharing a media item with a user of the system of FIG. 1;

FIG. 8 is an overview of the interaction of elements in the system when media items of a user are synchronized with the system of FIG. 1; and

FIG. 9 is a flowchart illustrating an example method of synchronizing media items of a user with the system of FIG. 1.

### DETAILED DESCRIPTION

The following embodiments relate generally to a system and method for sharing data relating to media items between user devices.

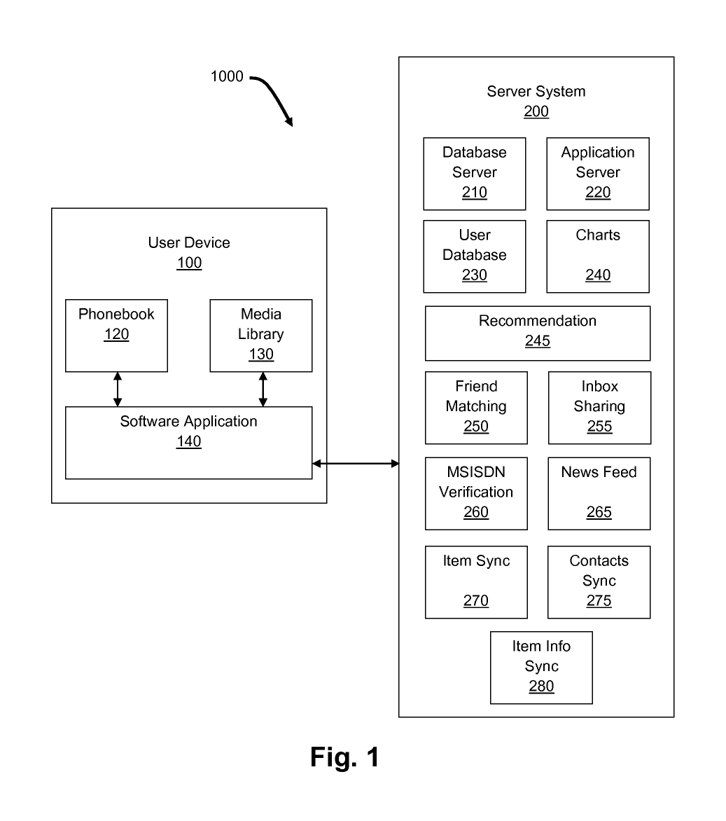

An embodiment of the present disclosure is illustrated in FIG. 1 in which a system 1000 comprises a user device 100 that is configured to communicate with a remote server system 200. The user device 100 comprises a phonebook 120 which includes a list of contacts associated with the user of the device 100. The contacts of the user of the device stored in the phone each have a unique identifier associated with the contact. The identifier may, for example, be an Mobile Station International Subscriber Directory Number (MSISDN) which is a unique directory number used to identify a mobile phone number internationally. Put another way, the MSISDN allows a device having a subscription to a mobile network to be uniquely identified globally.

The user device 100 also includes a media library 130 comprising a plurality of electronic media items associated with therewith. The media library may, for example, incorporate a library of music items registered to the user.

For example, the music library may include electronic music files associated with one or more service providers, such as Google Play Music, Apple Music, or Spotify. The music files associated with the music items in the library may be downloaded and stored in the memory on the user device 100 along with media identifiers which identify the music items. Alternatively, the music library 130 may comprise only the media identifiers that identify the music items without the music files themselves, so as to allow the music files to be streamed to the device 100 from a third-party service when requested by the user. In some arrangements, only a portion of the music files in the music library may be stored in memory.

The user device 100 also comprises a software application 140 configured to operate on the user device 100. The software application 140 is configured to access the phonebook 120 and the media library 130 so as to retrieve data therefrom. In particular, the software application 140 is configured to retrieve information from the phonebook 120 in the form of contact information and the associated unique contact identifiers, for example the MSISDN of each contact.

The software application 140 is also configured to access the media library 130 of the user device 100 and to retrieve media identifiers therefrom, that enable the media items in the media library to be identified. Examples of media identifiers include one or more of track name, artist name, and/or album name.

The software application 140 is also configured to communicate with server system 200. For example, the software application 140 may communicate with server system 200 using the communication hardware of the user device 100, for example using Wi-Fi or by transmitting data over a cellular network.

Server system 200 is configured to enable a user of the user device 100 to browse the media libraries of contacts stored in the phonebook 120 who are also registered with the system 200. The system 200 therefore stores information concerning the users of the system, in the form of contact identifiers, and information regarding the items in their media libraries, in the form of media identifiers, and manages access to the information as well as the manner in which the media files are shared between users.

Server system 200 comprises a database server 210 and an application server 220, as well as a number of functional elements including user database 230, charts 240, item recommendations 245, friend matching 250, item inbox sharing 255, MSISDN verification 260, newsfeed information 265, track sync 270, contacts sync 275, and item info sync 280. These functional elements will be described in further detail below.

MSISDN verification 260 involves the user associating a particular user device 100 with its unique identifier so as to register the device with the server system 200. In one example, the user device 100 provides to the server system 200 the unique identifier in the form of the MSISDN of the user device 100. A verification process then takes place to ensure that the user is genuine. This process will be described later in further detail.

Contacts sync 275 is configured to communicate with the software application 140 to update the user database 230, which stores information concerning each user and their associated contacts. In particular, the contacts sync function 275 operates to access the phonebook 120 of the user device 100 using software application 140 and to retrieve and second contact identifier information to the server system 200. The contact identifier information, including the unique identifier of each contact in the form of the MSISDN, is synchronized with the user database 230 to ensure that any changes to the contacts of the user are reflected in the server system 200. For example, if a new contact is added to phonebook 120 then the user database 230 is updated to reflect this change. In embodiments, the server system comprises a contacts database. When any changes are made in the user's phonebook, the system synchronizes those changes with the contacts database.

Database server 210 comprises a database in which a repository of data relating to media items is stored. In some arrangements, media files themselves are not stored in the database server 210. Instead, the database server 210 stores identifying information relating to the electronic music files in the form of a second media identifier. For example, in some arrangements the second media identifier may comprise one or more of a unique media item identifier, a name of the media item, artist name, and album name stored in the database.

Sync 270 operates to compare the items in the media library of the user of the user device 100 with information stored in the database server 210 associated with media items. For example, the sync function 270 accesses the media library 130 using the software application 140 and extracts from the media library particular fields of information concerning the media in the library for comparison with the corresponding fields associated with media items stored in the database server of server system 200. In embodiments, the sync function 270 gathers a play count or number of hits information from each item. For example, where the database server 210 stores track name, artist name, and album name, the sync function 270 extracts the corresponding fields from a media library and compares the media identifier in the music library with an identifier associated with media items in the database server 210 to identify which media items the user has stored in the media library 130. Accordingly, the system 200 is able to determine which of the media items in the database server 210 are present in the user's media library 130.

System 200 then stores in the database server information concerning the media items that it has matched in the media library 130 of the user device 100.

Friend matching 250 enables the system 200 to match contacts listed in the phonebook 120 of the user of user device 100 with other users of system 200 by using the unique contact identifier of each contact present in the phonebook 120. For example, where the unique identifier of each contact in the phonebook 120 is an MSISDN, the MSISDNs associated with each contact compared with identifiers stored in user database 230. Where a match between MSISDNs occurs as a result of the comparison, the user associated with the matched MSISDN is added as a friend or contact of the user of user device 100. Accordingly, matched users which are associated as friends or contacts have access to each other's music libraries.

Charts function 240 produces a number of different charts which indicate the behaviour of users of the system and may be accessible by users of the system. For example, charts may illustrate the most downloaded, the most viewed, or the most popular media items. Such charts may be separated based on the behaviour of users in particular age range or geographical area.

Newsfeed function 265 provides the user of the user device 100 with information concerning the activity of identified contacts of the user in the server system 200. For example, the newsfeed may include information such as the registration of users with the server system 200, the connection of users as friends, the listening by a particular user of a particular song, or the downloading of the particular song by a particular user.

### Adding a New Contact

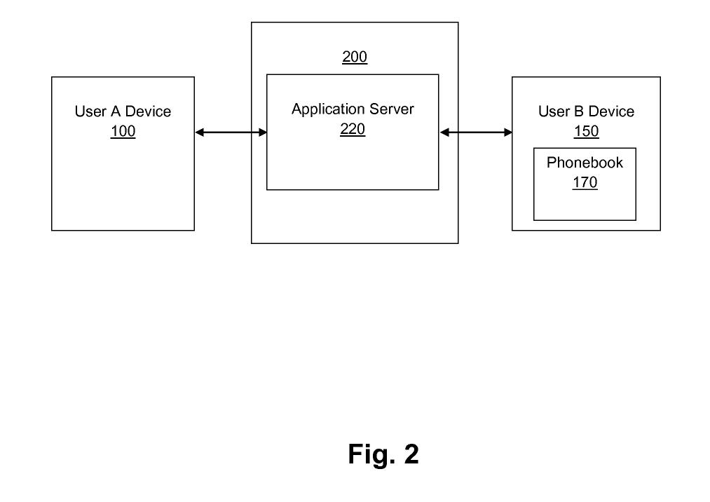

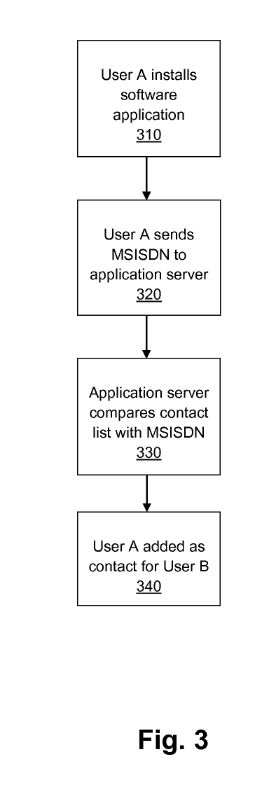

As described above, it is possible for users of the system 200 to connect with one another to allow media items to be shared between users. When a new user device registers with the server system 200 using the above-described MSISDN verification function 260, it is possible for the user of the new user device to link with an existing user as a new contact. An example of this will be illustrated with respect to FIGS. 2 and 3.

In this arrangement, an existing user, user B, has already registered with the server system 200 using second device 150. During this registration process, the contacts of user B stored in phonebook 170 have been stored in server system 200 using the unique contact identifier, such as the MSISDN. Accordingly, when the user A, using first user device 100, registers first user device 100 with the system 200 the application server 220 is able to match the unique contact identifier of first user device 100 with the unique contact identifier associated with the contact information of user B which was extracted from phonebook 170 of second user device 150.

FIG. 3 illustrates flowcharts of an example method for associating contacts. At step 310, user A installs software application 140 on first user device 100. The user then registers device 100 with the system 200 using the MSISDN verification function set out below. Specifically, user A sends the MSISDN of the user device 100 to the application server 220. The application server 220 then compares at step 330 the MSISDN of user device 100 with contact lists of the users already existing in the system 200. In the event that a match is identified between the MSISDN of the user (User A) of device 100, user A is added, at step 340, as a contact for user B. Accordingly, user B then has access to the media library of user A.

### User Registration

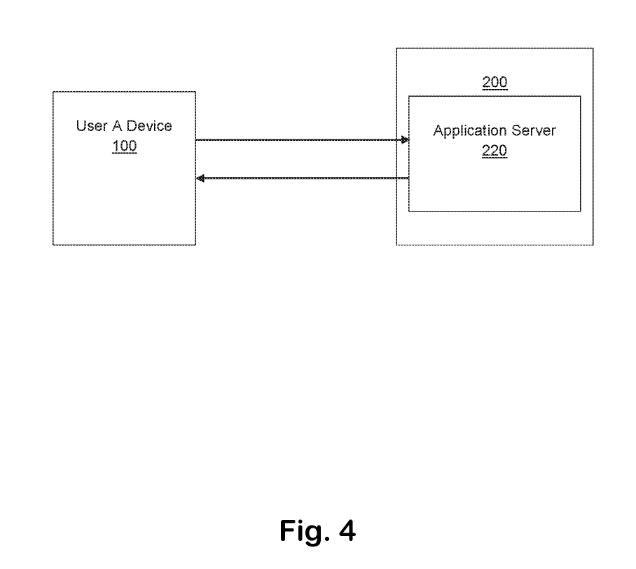

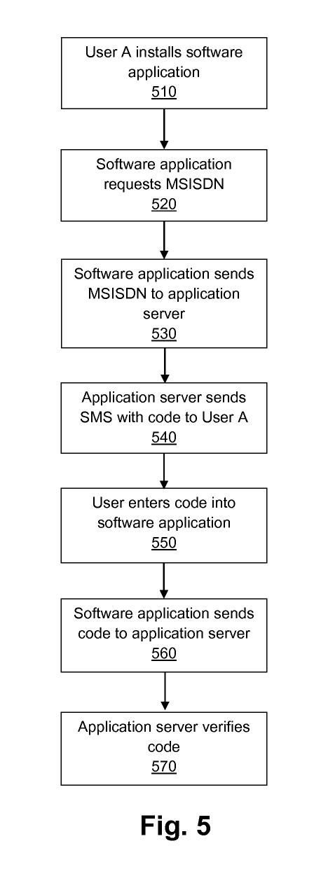

Server system 200 is configured such that before a user is able to access information stored in the server system 200 it is necessary to first register with the system. To do this, a verification process is undertaken to ensure that the user is registering using their device and not the device of another person and that the person seeking to register with the system is associated with the device. An example verification process is illustrated in FIGS. 4 and 5 and described below.

To perform verification, a unique identifier of the device 100 is used to ensure that the user device 100 is correctly verified. In the example of the unique identifier being an MSISDN, the user device 100 provides to the application server 220 the MSISDN of device 100 using software application 140. The application server 220 then transmits a message to device 100. The message transmitted by application server 220 to device 100 may not transmitted via software application 140. The communication transmitted to user device 100 from application server 220 is in the form of a message routed through another path than via software application 140.

For example, the message may be transmitted via an SMS which is received by user device 100. Since the MSISDN is a globally unique identifier, the message will only be sent to the specific device identified which has that particular MSISDN. Accordingly, only user device 100 will receive the message. Included in the message sent to the user device 100 is a verification code. The verification code is then provided back to the application server 220 from device 100 using the software application 140. Provided that the code returned to the application server 220 matches the code sent to the device 100 from the application server, the system 200 is able to verify that the user attempting to register with system 200 is indeed using device 100.

A flowchart illustrating an example verification procedure is set out in FIG. 5. At step 510, user A installs software application 140. At step 520, software application 140 requests the unique identifier of the user device 100 of user A. For example, the software application 140 requests the MSISDN of the user device 100. The software application 140 then sends the unique identifier to the application server 220 at step 530. Subsequently, the application server 220 sends a message, for example an SMS, to the device of user A. The SMS includes a verification code which the user then inputs into software application 140 at step 550. The software application 140 then sends a reply message at step 560 to the application server 220 which includes the code received from the application server 220. Application server 220 then verifies the received code by comparing the originally sent code with the verification code received from the device 100. In the event of a match between the two codes, the user of user device 100 is then considered to have been verified and is able to complete registration for the system 200.

### Sharing a Media File

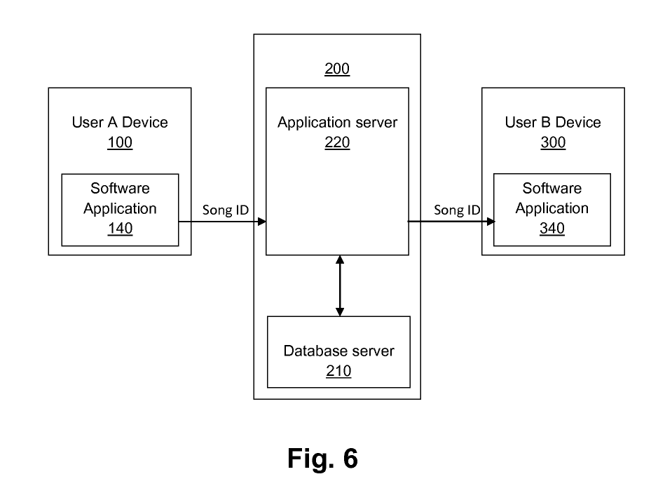

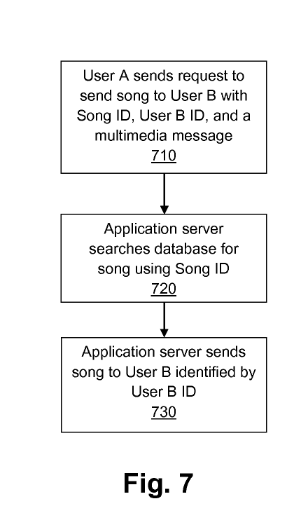

Server system 200 is able to allow media files, as well as media identifiers identifying media items associated with media files, to be shared between users and an example operation which allows this sharing to take place is set out below with respect to FIGS. 6 and 7.

In the example of FIG. 6, user A wishes to share a music file in the music library of their user device 100 with a contact, user B, that uses user device 300 having software application 340 running thereon. A flowchart illustrating an example procedure for sharing a music file is set out in FIG. 7.

At step 710 of FIG. 7, user A sends a request to send a music file to user B. To do this, user A sends from user device 100, using software application 140, a message to application server 220. The message sent to application server 220 comprises a media identifier which identifies a media item and which enables application server 220 to identify the media item that the user wishes to send the user B. For example, the media identifier may be one or more of a song name, an artist name, and an album name. The message also may comprise a contact identifier of the recipient user. This contact identifier may be in the form of a unique identifier of the user stored in the phone book 140 of the user device 100, such as the MSISDN of user B. The message sent to application server 220 may also include a message, such as a multimedia message, which is intended to accompany the resultant message sent to the user device 300 of user B.

At step 720 of FIG. 7, application server 220 receives the message from the device 100 and searches database server 210 to match the media identifier received from device 100 to a particular media item in database server 210. Upon matching the media item in database server 210, the application server sends information relating to the media item to user B. User B is identified based upon the contact identifier incorporated in the message from user device 100 and a new message is formulated which comprises the original multimedia message received from you device 100 along with information relating to the media item. At step 730, information relating to the media item is sent to device 300 via software applications 340 running on the device 300.

In some embodiments, the message may comprise a link to obtain a media file associated with the media item or a short sample of the media file from a third-party supplier of media files. In other embodiments, a sample of the media file or the entire media file may be sent from server system 200 to the recipient user device.

### Linking Media Libraries

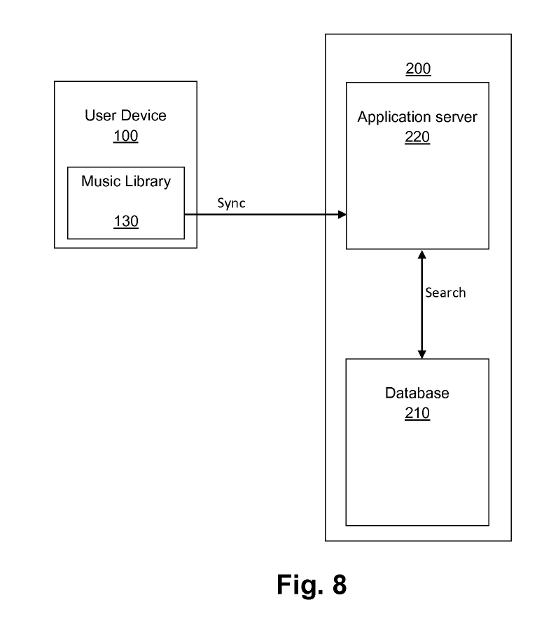

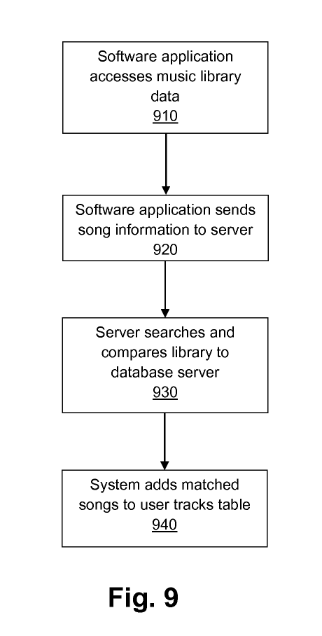

FIGS. 8 and 9 illustrate the linking and/or synchronization of a media library 130 associated with user device 100 with the server system 200 using info sync function 260. Specifically, as set out at step 910 of FIG. 9, the software application 140 accesses the media library 130 to retrieve media identifiers used to identify each media item in or associated with the music library.

For example, media identifiers may be artist name, song name, and album name. At step 920, the software application 140 sends information to application server 220 concerning the media identifiers in the music library 130. At step 930, application server 220 searches and compares the media identifiers extracted from the media library 130 with corresponding identifiers in database server 210. In the event that the identifiers extracted from the media library match identifiers in the database server 210, user database 230 is updated to reflect the change in the media library of the user.

In some arrangements, user database 230 stores a track table listing all media items, such as songs, associated with the media library of user device 100. Accordingly, updating user database 230 may involve adding an additional entry to the track table for a particular user. Updating user database 230 may instead involve populating the track table for the first time, in the event that the user has not yet synchronized the media items in the media library of a particular device with server system 200.

### Recommendation Algorithm

As illustrated in FIG. 1, server system 200 incorporates a media recommendation function 245 which enables system 1000 to provide recommendations of media to the software application 140 of the user device 100. These recommendations can then be displayed to the user of the user device 100.

The recommendation algorithm takes into consideration a number of different factors. For example, where the media items are music items, the algorithm can take into consideration one or more of the following factors: the music items included in the music library 130 of the user device 100, music items included in the music libraries of contacts such as the most common downloaded music items of contacts, the location of the user device 100, music items of other users of the system 1000 that are playing in the area near to the location of the user device 100, newly released music items, music items recently added to the music library of the user, preferred genres of music of the user, preferred artists of the user, libraries of users with most common downloaded media items, most common media items between contact's libraries, most common media items in mixes in the music library, and number of plays of a particular media item or album and the user's device.

The recommendation algorithm 245 takes into consideration one or more of the above factors and assigns a weight to each factor depending on its relative importance. In some arrangements, all media items are summed where a counter sums the number of times the media item is repeated. The final sum for each media item is then multiplied by the weight of the factor corresponding with that media item to produce a score associated with each media item. The media item with the overall highest score is then considered to be the strongest recommendation. Media items are then ordered based upon the final calculated score in decreasing order and displayed to the user on user device 100 with the most strongly recommended media item displayed first.

### Media Library Integration

User devices, such as mobile phones, are available from various different manufacturers. Accordingly, different users will likely use user devices which run with different operating systems which integrates different media library software applications that store media in different formats that are not readily compatible with one another. In addition, third-party media library software applications are available which do not readily conform or integrate with media library capabilities forming part of the operating systems of some devices. Accordingly, it can be a technical challenge to integrate the various different media libraries, such as music libraries, on various different devices so as to enable sharing of information between users.

System 1000 bridges the gap between these various different media libraries by implementing a proprietary database within server system 200 that is able to extract from the various different media libraries information that enables the system 1000 to identify the media items associated with each user.

For example, it is possible for system 200 to extract from a particular media library 130, using software application 140, media identifiers that can be used to identify media items. For example, fields such as song name, artist name, and or album name can be used to identify a music item. These fields extracted from music library 130 can be matched to a database 210 which has a stored set of media items identifiable by corresponding fields.

Accordingly, when a first user of a media library in a first format wishes to know which media items are present in the media library of a second user in a second format, system 200 is able to identify the media items in the second format and present them to the first user such that the first user can access the media items in the appropriate format for the device of the first user. Examples of library formats relating to particular operating system and factors include Apple Music and Google Music.

Accordingly, users are able to access information relating to music items of music libraries of other users in an appropriate format. In addition, when sharing media items between users, the media items may be shared in a number of different ways depending on the particular implementation of system 1000.

For example, music files associated with music items may be shared between users by providing links to external, third-party servers, such as web stores, through which the electronic music files may be obtained, purchased, or streamed. In some arrangements, server system 200 may also store media files locally which can be provided to a user.

User A would not therefore need to stream music files directly from the device of user B or from the music library of user B. Instead, the IDs, names and album name, as well as song information of users A and B are uploaded to server 210 to inform each user what the other one has in their music library, and direct them upon request to the allocated stores and streaming services.

The music may be streamed and/or downloaded from allocated music stores such as Apple Music and Google Play Music upon redirection either from the application server 220 or the software application 140. In addition, the software application 140 may operate to allow the user to play music from the music library 130 via the software application 140.

### Information Sharing

As set out above, users are able to access information relating to media items present in or associated with the media libraries of various users, as well as the sharing of media files.

In some arrangements, it is possible for the user to create a profile. This may include creating a profile name and uploading or sharing a picture as a profile picture. The user may, using the software application 140, view recommended charts which may in some embodiments be personalized to the user.

Using the software application 140, it is also possible to download or purchase particular media files from allocated media stores or streaming services. For example, the software application 140 may be configured to provide a direct link to a third party music store or streaming service. Alternatively, the system may act as an intermediary in such a transaction.

In some arrangements, the download or purchase of media files from a third-party media store or streaming service may be done in a batched manner. In this way, multiple songs can be purchased in a single action so as to download the songs together.

By providing access to information relating to the electronic media files in or associated with media libraries of other users, it is possible to allow the user to stream or play media items that correspond with media files found in or associated with media libraries of other users. As discussed above, this may be done by linking the user to a third party source or alternatively may involve the downloading of the media file from storage in server system 200. In some arrangements, it is also possible for either third-party sites or server system 200 to store samples, or shorter extracts from media files, to allow the user to try a particular media item before they purchase a complete version. For example, system 200 may provide the user, via the software application 140, a link to a third-party site such as Apple Music.

Server system 200 also provides the capability for particular songs to be shared via social media platforms or via newsfeeds.

The server system 200 also provides the capability to manage access to particular accounts in the contact list. For example, it is possible to follow or unfollow particular contacts or popular artists, to view the profiles of popular users, or to block or unblock contacts, to invite users from the phonebook 122 to register for the server system 200.

The sharing of messaging and media items with other users is also provided for example through the sending and receiving of direct messages or multimedia messages between users. In some arrangements messages may be directed through application server 220.

Other features available to the user include viewing followers, making profiles or particular media items invisible to other users, or performing re-verification of the user in the event that the unique identifier changes for example, if a user already registered with server system 200 obtains a new MSISDN, it is possible to re-verify the new number by repeating the steps of FIG. 5 based on the new MSISDN.

Server system 200 also provides the capability to search for media items by artist or track name, or to view charts based on popular, downloaded, and/or viewed media items. History of actions, common media items and profiles of friends can also be viewed. Activity of other users can also be viewed via a feed on the software application 140.

Whilst the above disclosure concerning server system 200 refers to the sharing of information relating to media items stored in a music library, it will be appreciated that other media items and media files may be shared using the same principles. For example, media files may be electronic video or image files stored in a video or image library on each user device. Each video file could be identified using fields such as featured subject matter, director of the video, producer of the video, or many others.

The above disclosure makes reference to a user device which should not be considered to be limited to any specific type of device. Indeed, the user device could, for example, take the form of a mobile phone, a tablet, a laptop, a PC, or other electronic device. In addition, the user device may be a portable electronic device.

It will be appreciated that the contacts list and/or the media libraries of each user may be located in the cloud rather than stored locally on each device. Accordingly, server system 200 may alternatively operate to extract information from the cloud-based services rather than directly from the user device.

Whilst the above disclosure recites that the MSISDN may be used as a unique reference number to identify contacts, it will be appreciate that other contact identifiers may be used in place of the MSISDN. Similarly, it will be appreciated that it is not necessary for the verification code to be transmitted via SMS. In other embodiments, the verification code is transmitted by at least one selected from the group comprising MSS, USSD Push, a network message addressed to the SIM, or a device message that points to the MSISDN such as: iMessage for iPhone, a message sent by a messaging system pointing to the MSISDN such as WhatsApp, Viber, Line.

A media item can be considered to be a particular song, image, video, film, or other media item which can be individually identified. A media file can be considered to be a viewable, audible, or playable file associated with a media item which allows the user to access the media item in question.

The described methods and control algorithms may generally be implemented by a computer program. The computer program may be in the form of computer-executable instructions or code arranged to instruct or cause a computer or processor to perform one or more functions of the described methods. The computer program may be provided to an apparatus, such as a computer, on a computer readable medium or computer program product. The computer readable medium or computer program product may comprise non-transitory media such as semiconductor or solid state memory, magnetic tape, a removable computer memory stick or diskette, a random access memory (RAM), a read-only memory (ROM), a rigid magnetic disc, and an optical disk, such as a CD-ROM, CD-R/W, DVD or Blu-ray. The computer readable medium or computer program product may comprise a transmission signal. An apparatus or device such as a computer may be configured to perform one or more functions of the described methods.

The above disclosure makes reference to a number of different databases, including a database server, an application server, and a user database. It will be appreciated that the particular hardware arrangement set out in the examples above should not be considered to be essential. Indeed, the above-described system may be integrated or separated into a number of different servers or computers as needed for the specific implementation without departing from the disclosure.

Other variations and modifications will be apparent to the skilled person. Such variations and modifications may involve equivalent and other features which are already known and which may be used instead of, or in addition to, features described herein. Features that are described in the context of separate embodiments may be provided in combination in a single embodiment. Conversely, features which are described in the context of a single embodiment may also be provided separately or in any suitable sub-combination. It should be noted that the term “comprising” does not exclude other elements or steps, the term “a” or “an” does not exclude a plurality, a single feature may fulfil the functions of several features recited in the claims and reference signs in the claims shall not be construed as limiting the scope of the claims. It should also be noted that the Figures are not necessarily to scale; emphasis instead generally being placed upon illustrating the principles of the present disclosure.

1. A server system for sharing data from a first device using a first MSISDN with a second device using a second MSISDN, wherein the server system is arranged to:
receive a first media identifier from the first device, wherein the first media identifier identifies a media item;
receive a first contact identifier from the first device, wherein the first contact identifier comprises the second MSISDN;
identify that the media item identified by the first media identifier corresponds to a media item identified by a second media identifier, wherein the second media identifier is stored by the server system; and
send sharing data to the second device, wherein the sharing data identifies the media item.

2. A server system according to claim 1, further arranged to verify the first device, wherein the verification of the first device comprises:
receiving the first MSISDN;
sending an SMS to the first device, wherein the SMS comprises a verification code; and
receiving data comprising the verification code.

3. A server system according to claim 1, further arranged to verify the second device, wherein the verification of the second device comprises:
receiving the second MSISDN;
sending an SMS to the second device, wherein the SMS comprises a verification code; and
receiving data comprising the verification code.

4. A server system according to claim 1, further arranged to add the second media identifier to a list of second media identifiers associated with the first MSISDN.

5. A server system according to claim 1, wherein the sharing data identifies all media items respectively identified by the second media identifiers in the list of second media identifiers.

6. A server system according to claim 1, wherein the server system is configured to recommend a new media item to the first device based on at least one of:
the media item identified by the first media identifier;
a media item identified by a third media identifier received from the second device; and
the location of the first device.

7. A server system according to claim 1, wherein the media item is an electronic music item.

8. A server system according to claim 1, wherein the first media identifier and/or third media identifier is at least one of an artist name, a song name, and an album name.

9. A system comprising a first device using a first MSISDN, a second device using a second MSISDN, and the server system according to claim 1.

10. A system according to claim 8, wherein the first device is arranged to:
extract the first media identifier from a first media library; and
extract the first contact identifier from a first contact list.

11. A system according to claim 8, wherein the first media library is stored on the first device.

12. A system according to claim 8, wherein the first contact list is stored on the first device.

13. A system according to claim 8, wherein the first device is arranged to extract a fourth media identifier from a third media library, and optionally wherein the third media library is stored on the first device.

14. A system according to claim 8, wherein the second device is arranged to identify that the media item corresponding to a second media identifier is in a media library stored in a server remote from the second device.

15. A system according to claim 13, wherein the second device is arranged to obtain the media item from the media library stored in a server remote from the second device.

16. A method in a server system for sharing data from a first device using a first MSISDN with a second device using a second MSISDN, the method comprising:
receiving a first media identifier from the first device, wherein the first media identifier identifies a media item;
receiving a first contact identifier from the first device, wherein the first contact identifier comprises the second MSISDN;
identifying that the media item identified by the first media identifier corresponds to a media item identified by second media identifier, wherein the second media identifier is stored by the system; and
sending sharing data to the second device, wherein the sharing data identifies the media item.

17. A method according to claim 15, further arranged to verify the first device, wherein the verification of the first device comprises:
receiving the first MSISDN;
sending an SMS to the first device, wherein the SMS comprises a verification code; and
receiving data comprising the verification code.

18. A method according to claim 15, further arranged to verify the second device, wherein the verification of the second device comprises:
receiving the second MSISDN;
sending an SMS to the second device, wherein the SMS comprises a verification code; and
receiving data comprising the verification code.

19. A method according to claim 15, further arranged to add the second media identifier to a list of second media identifiers associated with the first MSISDN.

20. A method according to claim 15, further comprising recommending a new media item to the first device based on at least one of:
the media item identified by the first media identifier;
a media item identified by a third media identifier received from the second device; and
the location of the first device.

21. A method according to claim 15, wherein the media item is an electronic music file.

22. A method according to claim 15, wherein the first media identifier is at least one of an artist name, a song name, and an album name.

23. A computer-readable medium comprising instructions which, when executed by a processor, cause the processor to implement the method of claim 15.
